(19) United States
(12) Patent Application Publication
(10) Pub. No.: US 2025/0290772 A1
(43) Pub. Date: Sep. 18, 2025

(54) SYSTEMS, METHODS, AND MEDIA FOR ADAPTING A SPECTRAL DENSITY BASED ON VARYING ENVIRONMENTAL OPERATING CONDITIONS

(71) Applicant: NovAtel Inc., Calgary (CA)

(72) Inventors: Michael Bobye, Calgary (CA); Brett Kruger, Calgary (CA)

(21) Appl. No.: 18/583,368

(22) Filed: Feb. 21, 2024

Related U.S. Application Data
(60) Provisional application No. 63/497,574, filed on Apr. 21, 2023.

(51) Int. Cl. G01C 25/00

(52) U.S. Cl. CPC G01C 25/005

(57) ABSTRACT

Techniques are provided for adjusting a spectral density for computing a filtering solution. In an embodiment, a rolling history of correction data for a current epoch and previous epochs is created to compute a statistical value. The statistical value can be used to compute long-term and short-term averages for the current epoch. The long-term and short-term averages can be used to compute a ratio value that can be a scale factor for adjusting the spectral density. In an embodiment, sensor data for a current epoch can be obtained and compared to one or more threshold values and the spectral density can be adjusted when the threshold values are exceeded. In an embodiment, misclosure values from two different filters may be used to determine if a steady-state model of a first filter or a disturbed model of a second filter should be used to compute a filtering solution.

### CROSS-REFERENCE TO RELATED APPLICATIONS

The present application claims the benefit of U.S. Provisional Patent Application Ser. No. 63/497,574, which was filed on Apr. 21, 2023, by Michael Bobye et al., for SYSTEMS, METHODS, AND MEDIA FOR ADAPTING A SPECTRAL DENSITY BASED ON VARYING ENVIRONMENTAL OPERATING CONDITIONS, which is hereby incorporated by reference.

### BACKGROUND

### Technical Field

The invention relates generally to filtering systems and solutions, and in particular, to systems, methods, and media for adapting a spectral density based on varying environmental operating conditions.

### Background Information

An inertial navigation system (INS) typically combines inertial measurement unit (IMU) data with additional complementary data from external aiding sensors such as, but not limited to, global navigation satellite systems (GNSS), barometers, magnetometers, etc. IMUs are self-contained systems that can provide navigation quantities, i.e., IMU data, such as accelerations and rotation rates of a body of interest (e.g., vehicle). In certain instances, IMUs may include six orthogonally positioned sensors. Such sensors may include three gyroscope sensors that measure rotation rates and three accelerometer sensors that measure accelerations. These physical sensors can be subject to errors (e.g., biases), which if not correctly dealt with or estimated can cause problems in a navigation solution computed by, for example, a navigation filter.

The IMU errors may be modelled, and the navigation filter may use the model, i.e., error model, to correct errors from the IMU measurements. In certain instances, manufacturers of IMUs provide steady state statistics observed while the IMU is under heavily controlled lab conditions. One such statistic is a spectral noise density (i.e., spectral density) that describes the characteristic time propagation of the IMU sensor errors. The spectral noise density can be used as input to the filtering error model that can then be used as a filtering method implemented by the navigation filter, e.g., an INS filter, to correct IMU sensor errors and provide a final solution of interest, e.g., a GNSS/INS combined solution.

Proper characterization of the spectral noise density is necessary to properly weight sensor inputs within the navigation filter, and to accurately assess errors in the solution. However, the steady state statistics that may be provided by the manufacturer of the IMU are static and for a very limited set of environmental operating conditions that can be difficult to maintain for end user applications. For example, the process noise for the error model may be set low to ensure that the steady state solution is accurately characterized.

However, this results in the inability to efficiently and/or accurately assess the increased IMU errors that are produced in disturbed environments (e.g., fluctuating temperatures, fluctuating vibrations, etc.) Specifically, the static steady state model will mischaracterize the increased IMU errors since the process noise is set for operating in a steady state environment. Therefore, the navigation filter, e.g., INS filter, cannot use such static steady state models in a disturbed environment to efficiently and/or accurately determine the navigation solution, e.g., a GNSS/INS combined solution.

As an alternative, and to account for environments subject to higher likelihood of disturbance, the spectral density may be set to a higher static value. By setting the spectral density to a higher value, the IMU error corrections can respond to the disturbance more quickly. As a result, the navigation filter may use this type of static error model in disturbed environments (e.g., temperature variable, vibration variable, etc.) to react more quickly to compute an accurate navigation solution. However, increasing spectral density of the IMU error corrections results in increased reliance on noisy external aiding sensor data, which negatively affects the efficiency and/or accuracy of the navigation filter to compute the navigation solution during steady state conditions. Therefore, both conventional approaches that use static models with IMUs have their drawbacks.

Accordingly, what is needed is a technique for accurately adapting a spectral noise density based on varying environmental conditions (e.g., steady state environment and variable environments due to changes in environmental conditions) such that an error model, that relies on the spectral density, can be used in the varying environmental conditions to accurately and efficiently compute a navigation solution.

### SUMMARY

Techniques are provided for adapting a spectral density based on varying environmental operating conditions. The variations in environmental operation conditions may be caused by any of a variety of different factors. Such factors may include, but are not limited to, fluctuations (i.e., changes) in temperature, vibrations, fluctuations in vibrations, fluctuations in magnetic field, or any other type of potential disturbance in the environmental operating conditions that may be detected by a source of information.

As will be described in further detail below, a processor (e.g., an adaptive spectral density module executed by a processor) may evaluate different data (e.g., sensor data, IMU error corrections, or any other source of information that can provide an indication regarding a potential disturbance in the environmental operating conditions) associated with a system (e.g., navigation system, filtering system, tracking system, etc.) to determine if the system is operating in a steady state environment or a disturbed environment during a current epoch. The processor may adjust or maintain the spectral density at a steady state value when it is determined that a filter (e.g., Kalman filter, tracking filter, navigation filter, etc.) is operating in a steady state environment during the current epoch. Further, the processor may adjust or maintain the spectral density at an increased value when it is determined that the filter is operating in a disturbed environment during the current epoch.

For example, a navigation filter may start-up and the processor may detect or determine that the navigation filter is operating in a steady-state environment. As such, the processor, at start-up, may start the spectral density at a steady-state value. The processor may maintain the spectral density at the steady-state value while the navigation filter is operating in the steady-state environment. When the processor detects or determines that there is a disturbance in the environmental operating conditions, the processor may increase the spectral density. The spectral density may be maintained at the increased value while the disturbance persists. The processor may then adjust the spectral density back to the steady-state value when it is determined that the disturbance is no longer present in the environmental operating conditions.

As another illustrative example, the navigation filter may start-up and the processor may detect or determine that the navigation filter is operating in a disturbed environment. As such, the processor may, at start-up, start the spectral density at an increased value to account for the disturbed environment. The processor may maintain the spectral density at the increased value until it is determined that the disturbance is no longer present in the environmental operating conditions. Once it is determined that there is no longer a disturbance, the processor may adjust the spectral density at the steady-state value. These are simply two illustrative examples, and it is expressly contemplated that the one or more embodiments as described herein may start, maintain, and adjust the spectral density to a variety of different values and at a variety of different times based on determining whether any type of filter (e.g., navigation filter, Kalman filter, tracking filter, etc.) of any type of system (e.g., a navigation system, filtering system, tracking system, etc.) is operating in a disturbed or steady-state environment.

By adjusting the spectral density (e.g., real-time, near real-time, post-processing), the filter can use a model (e.g., an error model) that is best suited, i.e., accounts for, the environmental conditions in which the filter is operating during the current epoch. As a result, the filter can efficiently and accurately determine a solution (e.g., navigation solution) in varying environmental operating conditions based on the spectral density that is adapted according to the one or more embodiments as described herein.

In a further embodiment, a plurality of different filters may be used. A first filter, i.e., primary filter, may use a first model (e.g., steady state error model) while each of one or more secondary/backup filters may use a second model (e.g., an error model) with an increased spectral density to account for a disturbed environment.

The processor may use misclosure values from the plurality of different filters to compute a ratio value. The ratio value may provide an indication as to when, for example, an INS solution and GNSS solution at the primary filter are diverging by a threshold amount relative to the divergence at each of the secondary/backup filter. When the divergence at the primary filter exceeds the threshold value, the processor may determine that the environmental operating conditions have changed from steady state to disturbed environment. When it is determined that the environmental operating conditions have changed to disturbed, a particular secondary/backup filter may be utilized to compute the solution (e.g., navigation solution) until it is determined that the environmental operating conditions have changed back to steady state. When the environmental operating conditions have changed back, the primary filter may be used again to compute the solution (e.g., navigation solution).

### BRIEF DESCRIPTION OF THE DRAWINGS

The description below refers to the accompanying drawings, of which:

FIG. 1A is an illustration of an example system environment for adapting a spectral density based on varying environmental operating conditions according to the one or more embodiments described herein;

FIGS. 1B and 1C depict different example system environments, respectively, for adapting a spectral density based on varying environmental operating conditions according to the one or more embodiments described herein;

FIG. 2 is a flow diagram of a sequence of steps for using internal data to adapt a spectral density based on varying environmental operating conditions according to the one or more embodiments as described herein;

FIG. 3 is a flow diagram of a sequence of steps for using external data to adapt a spectral density based on varying environmental operating conditions according to the one or more embodiments as described herein; and

FIG. 4 is a flow diagram of a sequence of steps for using misclosure values to switch between filters that use different models according to the one or more embodiments as described herein.

### DETAILED DESCRIPTION OF AN ILLUSTRATIVE EMBODIMENT

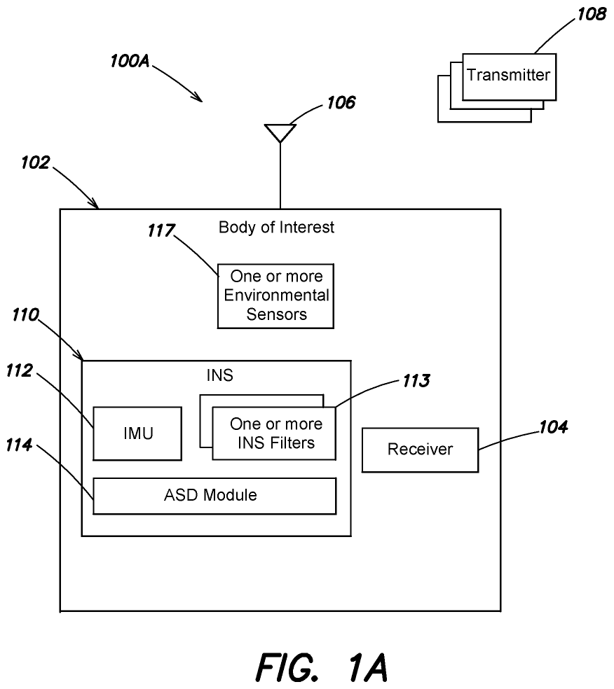

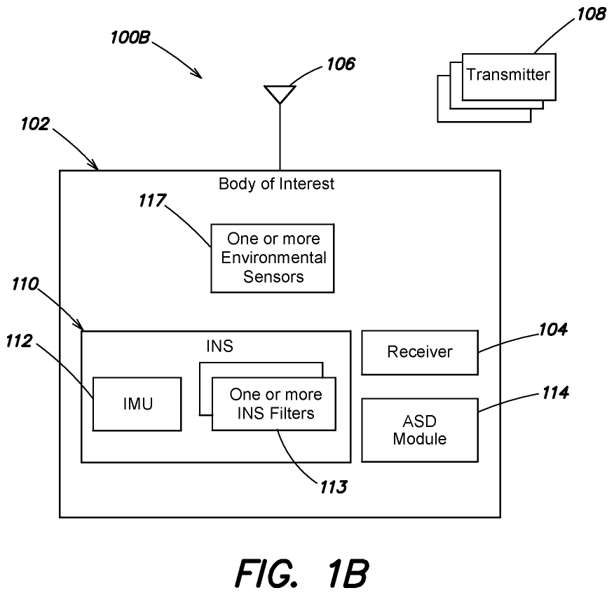

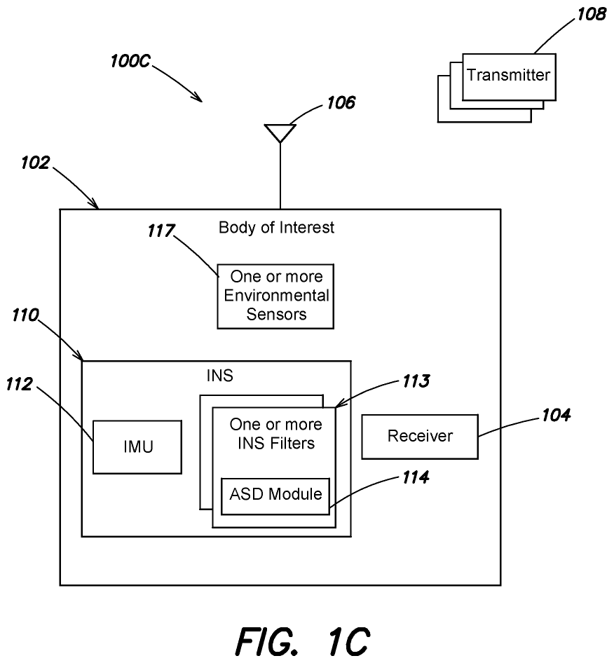

FIG. 1A is an illustration of an example system environment 100A for adapting a spectral density based on varying environmental operating conditions according to the one or more embodiments described herein. System environment 100A includes a body of interest 102, e.g., a moving vehicle, a stationary object, etc. Coupled to the body of interest 102 may be a receiver 104, an inertial navigation system (INS) 110, and an antenna 106. Additionally, one or more environmental sensors 117 may be, optionally, coupled to the body of interest 102. The antenna 106, coupled to the body of interest 102 and in communication with receiver 104, may receive one or more signals from one or more transmitters 108.

In an embodiment, the one or more transmitters 108 may be one or more Global Navigation Satellite System (GNSS) satellites that transmit one or more navigation signals, e.g., GNSS satellite signals (not shown). Although reference may be made to transmitters 108 being GNSS satellites transmitting GNSS satellite signals, it is expressly contemplated that the one or more embodiments as described herein may be utilized with any of a variety of different types of transmitters 108. For example, transmitters 108 may be terrestrial transmitters that transmit any of a variety of different navigation signals. As such, the description of transmitters 108 being GNSS satellites that transmit GNSS signals should be taken for illustrative purposes only.

Receiver 104 may, based on the reception of signals at the antenna 106, produce raw measurements (e.g., GNSS raw measurements), such as pseudoranges, carrier phases, and Doppler velocities; position (e.g., GNSS position), velocity (e.g., GNSS velocity) and time (e.g., GNSS time), position covariance, and velocity covariance; and, as appropriate, GNSS observables. The GNSS raw measurements, GNSS position, velocity and time, the position covariance and the velocity covariance and the GNSS observables may be hereinafter referred to collectively as “GNSS data.” Additionally, the GNSS position, velocity, and time may be referred to as a GNSS solution.

The one or more environmental sensors 117, which are optional, may be configured to detect or measure one or more characteristics of the system environment 100A in which body of interest 102, receiver 104, and INS 110 operate. For example, the one or more environmental sensors 117 may include a temperature sensor that detects a temperature, measures a temperature, measures a rate of change in temperature, etc. In addition or alternatively, the optional one or more environmental sensors 117 may include a vibration sensor (i.e., a vibration detection device) that detects vibrations, measures vibrations, measures a rate of change in vibrations, etc.

The INS 110 includes an inertial measurement unit (IMU) 112 that reads data from sensors (e.g., one or more accelerometers and/or gyroscopes) that produce IMU measurements. In an embodiment, the sensors may include up to three orthogonally positioned gyroscope sensors configured to measure rotation rates and three orthogonally positioned accelerometer sensors configured to measure acceleration. Additionally, the sensors may include a temperature sensor, magnetometers, or a different sensor that is configured to detect or measure one or more parameters in which the IMU operates. In an embodiment, the IMU 112 may be in close proximity to the one or more environmental sensors 117 when the one or more environmental sensors 117 are included in system environment 100A.

The INS 110 further includes one or more INS filters 113. In an embodiment, each of the one or more INS filter 113 may operate as a Kalman filter, extended Kalman filters, unscented Kalman filters, Particle filter, any other type of navigation filter, or any type of filter that may be used to determine a solution. Each of the INS filters 113 may process the IMU measurements to compute INS based position, velocity, and/or attitude. The computed INS based position, velocity, and/or attitude may be referred to as an INS solution. Additionally, the INS filter may process, in a known manner, the GNSS data, when available, and the IMU measurements to produce GNSS/INS based position, velocity, and/or attitude. The computed GNSS/INS based position, velocity, and/or attitude may be referred to as a GNSS/INS solution. The receiver 104, INS 110, and IMU 112 may include processors, memory, storage, other hardware, software, and/or firmware (not shown).

The INS 110 may also include an adaptive spectral density (ASD) module 114 that implements the one or more embodiments as described herein. The ASD module 114 may adapt, i.e., adjust, the spectral noise density based on environmental operating conditions to generate or modify a model (e.g., an error model) in direct response to varying environmental operating conditions. As a result, the INS filter 113 can efficiently and accurately compute a solution (e.g., navigation solution) in the varying environmental operating conditions based on the adaptable spectral noise density according to the one or more embodiments as described herein.

In an embodiment, the ASD module 114 may be hardware, software, or a combination of hardware and software. In an embodiment, the ASD module 114 is executed by a processor (not shown).

FIGS. 1B and 1C depict different example system environments 100B and 100C, respectively, for adapting a spectral density based on varying environmental operating conditions according to the one or more embodiments as described herein. FIG. 1B is similar to FIG. 1A, however the ASD module 114 of FIG. 1B is external to the INS 110 and coupled to the body of interest 102. FIG. 1C is also similar to FIG. 1A, however the ASD module 114 of FIG. 1C is internal to at least one INS of the filters 113.

INS filter 113, e.g., Kalman filter, may implement a filtering method to correct IMU errors to compute a navigation solution. For example, the INS filter 113 may implement the following update procedure when computing a navigation solution:

$${x}_{k}^{-} = {Φ}_{k , k - 1} {x}_{k - 1}^{+}$$

$${P}_{k}^{-} = {Φ}_{k - 1 , k} {P}^{-} {Φ}_{k - 1 , k}^{T} + {Q}_{k}$$

$${K}_{k} = {P}_{k}^{-} {{H}_{k}^{T} [ {H}_{k} {P}_{k}^{-} {H}_{k}^{T} + {R}_{k} ]}^{- 1}$$

$${\hat{x}}_{k}^{+} = {\hat{x}}_{k}^{-} + {K}_{k} ( {\hat{z}}_{k} - {H}_{k} {\hat{x}}_{k}^{-} )$$

$${P}_{k}^{+} = [ I - {K}_{k} {H}_{k} ] {P}_{k}^{-}$$

here xₖ is the current state estimate, k is an indication of a current epoch, k−1 is an indication of a previous epoch, H is a design matrix, P is the state covariance matrix, and Φ_{k-1,k} is a state transition matrix used to project time dependencies of the model dynamics matrix. The variable \hat{z}ₖ is the update observation. The Q matrix represents the time propagation of the spectral densities of the state elements. R is the observation variance matrix and K is the Kalman gain matrix. The superscript −− indicates a point in time before an IMU error correction is applied while the superscript + is to indicate a point in time after an IMU error correction is applied.

In the update procedure, Pₖ⁻=Φ_{k,k-1}P⁻Φ_{k,k-1}^{T}+Qₖ may be the error model according to the one or more embodiments as described herein. Additionally, Qₖ may correspond to a spectral density value according to the one or more embodiments as described herein. In an embodiment, when Q is increased, the IMU corrections are more heavily weighted such that the IMU corrections have a larger impact/influence in the error model, e.g., Pₖ⁻=Φ_{k,k-1}P⁻Φ_{k,k-1}^{T}+Qₖ.

Further, Kₖ(\hat{z}ₖ−Hₖ\hat{x}ₖ\hat{x}ₖ⁻) is a correction portion of the update procedure and a vector of state corrections (Cₖ) is equal to Kₖ(\hat{z}ₖ−Hₖ\hat{x}ₖ⁻). Therefore, Cₖ=Kₖ(\hat{z}_{K}−Hₖ\hat{x}ₖ⁻).

As will be described in further detail below, the ASD module 114 may statistically analyze a window of error corrections to determine a statistical representation of a current state of the error corrections, e.g., IMU gyroscope error corrections. The ASD module 114 may use the statistical representation to compute a long-term average and a short-term average that can be compared to determine if the short-term average is deviating from the long-term average. If the short-term average deviates from (e.g., increases relative to) the long-term average, the ASD module 114 may determine that the INS filter 113 is operating in a disturbed environment (e.g., detecting a temperature, detecting fluctuations (i.e., changes) in the temperature, detecting a rate of change in the temperature, detecting vibrations, detecting fluctuations in the vibrations, detecting a rate of change in the vibrations, detecting a magnetic field, detecting fluctuations in the magnetic field, detecting a rate of change in the magnetic field, or any other type of potential disturbance in the environmental operating conditions that may be detected by a source of information, etc.) for the current epoch.

Accordingly, the ASD module 114 may adjust, e.g., increase, the spectral density for the current epoch such that the model (e.g., error model) is generated or modified for the disturbed environmental operating conditions. Advantageously, the INS filter 113 can adjust the spectral density for a model (e.g., error model) based on the varying environmental conditions in which the INS filter 113 operates. As a result, the INS filter 113 can use the model (e.g., error model) as part of the update procedure to efficiently and accurately determine a solution (e.g., navigation solution) in varying environmental operating conditions.

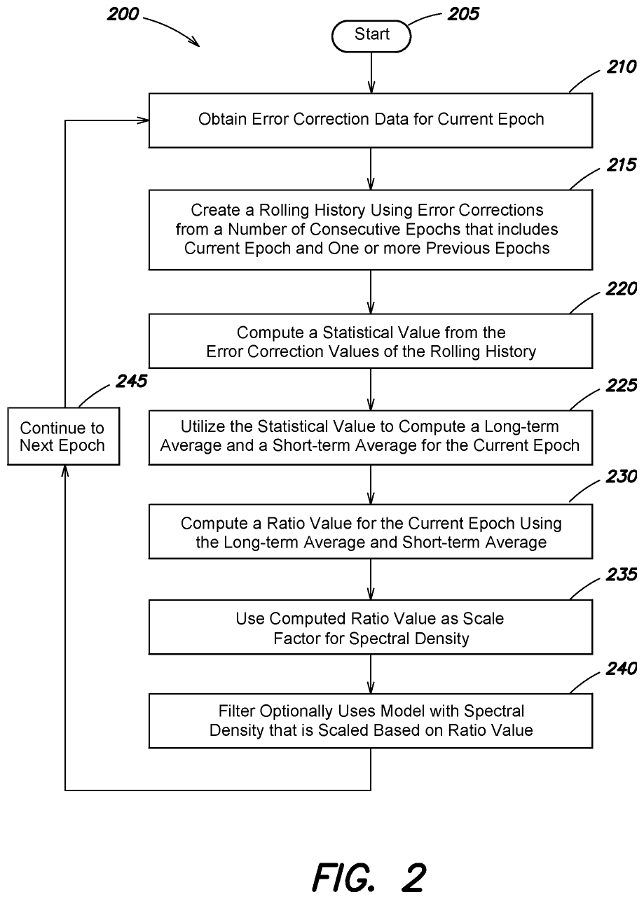

FIG. 2 is a flow diagram of a sequence of steps for using internal data to adapt a spectral density based on varying environmental operating conditions according to the one or more embodiments as described herein. As used herein, internal data may be any data that is generated, used, or obtained during a filtering process that is implemented by any of a variety of different filters such as, but not limited to, INS filter 113. For example, IMU error correction data that is generated during an update procedure implemented by INS filter 113 may be an example of internal data. However, it is expressly contemplated that the one or more embodiments as described herein are applicable to any of a variety of different types of internal data. As such, the use of IMU error correction data in relation to FIG. 2 is for illustrative purposes only.

Procedure 200 starts at step 205 and continues to step 210. At step 210, the ASD module 114 obtains error correction data for a current epoch (Cₖ). For example, the error correction may be a gyroscope error correction, e.g., z-gyroscope bias state correction. For this example, let it be assumed that the current epoch is update epoch 5 and the INS filter 113 implements the update procedure to determine the following error correction for the current epoch (Cₖ):

| Update Epoch | Cₖ (°/s) |
|---|---|
| 5 | 0.053 |

Above, °/s may be a unit angular velocity and represent degrees per second. According to the one or more embodiments as described herein, epoch and update epoch may be used interchangeably.

The procedure continues to step 215 and the ASD module 114 creates a rolling history using error corrections from a number of consecutive epochs (e.g., update epochs) that includes the current epoch and one or more previous epochs. In an embodiment, the number, e.g., window size, of consecutive update epochs is 5 and the ASD module 114 creates a rolling history using the error correction values from the 5 consecutive update epochs.

A window size of 5 is for illustrative purposes only, and it is expressly contemplated that the window size may be of any value. In an embodiment, the window size may be any value that is equal to or greater than 2. For this example, let it be assumed that the window size is 5. As such, the ASD module 114 may create a rolling history (History Epoch 1) that includes 4 previous update epochs, e.g., update epochs 1 through 4, and the current update epoch, e.g., update epoch 5. Therefore, History Epoch 1 includes the error corrections from update epochs 1 through 5. For example, the ASD module 114 may create History Epoch 1 as follows:

History Epoch 1

| Update Epoch | Cₖ (°/s) |
|---|---|
| 1 | 0.099 |
| 2 | 0.036 |
| 3 | 0.024 |
| 4 | 0.038 |
| 5 | 0.053 |

After the completion of procedure 200 where the current epoch is epoch 5, the next epoch will be the current epoch. For this example, let it be assumed that the next epoch is epoch 6. When epoch 6 is the current update epoch, the procedure 200 repeats for a next iteration, and the ASD module 114 may create a next rolling history (History Epoch 2) at step 215 for the next iteration. History Epoch 2 may be created by removing the oldest epoch (e.g., update epoch 1) from History Epoch 1 and adding the error correction value for update epoch 6 to History Epoch 1. Therefore, History Epoch 2 includes epochs 2, 3, 4, 5, 6 and their respective error correction values.

Accordingly, and on each iteration of procedure 200, the ASD module 114 may create a next rolling history at step 215 for the current update epoch and one or more previous update epochs.

The procedure 200 continues to step 220 and the ASD module 114 computes a statistical value from the error correction values of the rolling history. In this example, the current epoch is update epoch 5. As such, the ASD module 114 may compute a statistical value using the error correction values in History Epoch 1. In an embodiment, the ASD module 114 may use a root mean square (RMS) to compute the statistical value as follows:

$$RMS = \sqrt{\frac{{\sum }_{k = 0}^{n} {C}_{k}^{2}}{n}} ,$$

where n is the window size.

Although the example used herein calculates the statistical value using the RMS, it is expressly contemplated that the one or more embodiments as described herein can perform any of a variety of different statistical analyses on a rolling history of internal data according to the one or more embodiments as described herein. For example, other statistical analyses that may be performed include, but are not limited to, calculating a standard deviation value for internal data of a rolling history, calculating an absolute accumulation value for internal data of a rolling history, calculating a slope value for internal data of a rolling history, etc.

Returning to the example, the five error correction values for History Epoch 1 are 0.099, 0.036, 0.024, 0.038, and 0.053. As such, the ASD module 114 uses the RMS to compute the statistical value for History Epoch 1 as 0.056 based on the RMS formula as described above. An RMS value is a measure of the magnitude of a set of numbers. As such, the statistical value may represent a magnitude of the error correction values included in a rolling history (e.g., 5 epochs).

The procedure continues to step 225 and the ASD module 114 utilizes the statistical value to compute a long-term average and a short-term average for the current epoch. As will be described in further detail below, the long-term average and the short-term average of the RMS value can be used to detect and quantify a level of disturbance in the environmental operating conditions for the current epoch. In an embodiment, the ASD module 114 may compute the short-term average for the current epoch (Sₖ) and long-term average for the current epoch (Lₖ) as:

$${S}_{k} = α {RMS}_{k} + ( 1 - α ) {S}_{k - 1}$$

$${L}_{k} = β {RMS}_{k} - ( 1 - β ) {L}_{k - 1}$$

where α is a short-term weight and β is a long-term weight. In an embodiment, α and β may be preconfigured or user defined.

Short-term averages respond quickly to changes in values (e.g., RMS value), while long-term averages are slower to react to changes in values. Stated another way, an increasing RMS value for a rolling history that includes the current epoch will have a greater impact on the short-term average than on the long-term average.

According to the one or more embodiments as described herein, the long-term average can be used as a baseline performance indicator, while the short-term average can be used as an indicator for a current time frame (e.g., the rolling history that includes the current update epoch). Therefore, it would be expected that the long-term average and the short-term average will be the same or similar when the RMS value for the rolling history that includes the current epoch is consistent with the historical RMS values that define the long-term average. This would likely be indicative of the INS filter 113 operating in a steady state environment during the current update epoch. Conversely, it would be expected that the short-term average would increase relative to the long-term average when the RMS value indicates that that the magnitude of the error corrections for the rolling history that includes the current epoch is large relative to the historical RMS values. This would likely be indicative of the INS filter 113 operating in a disturbed environment during the current update epoch.

The procedure continues to step 230 and the ASD module 114 computes a ratio value for the current epoch using the long-term average and short-term average. In an embodiment, the long-term average is used as the denominator of the computed ratio and the short-term average is used as the numerator of the computed ratio. In an embodiment, the ASD module 114 calculates the ratio value for the current epoch (Ratioₖ) as follows:

$${Ratio}_{k} = \frac{{S}_{k}}{{L}_{k}}$$

Because the long-term average provides an indication regarding the baseline performance and the short-term average provides an indication regarding the recent (i.e., rolling history that is more heavily weighted by the current update epoch) behavior, the ratio value can be used to quantify the behavior of the INS filter 113 during the current update epoch relative to the baseline performance of the INS filter 113. An increasing ratio value, e.g., increasing from a value of 1, may provide an indication that the INS filter 113 is behaving differently from its baseline performance. Therefore, an increasing ratio value can be indicative of the INS filter 113 operating in more disturbed environmental operating conditions during the current update epoch. However, a ratio value of 1 or a ratio value that is close to 1 may provide an indication that the INS filter 113 is behaving similarly to its baseline performance. Therefore, a ratio value of 1 or close to 1 can be indicative of the INS filter 113 operating in a steady state environment during the current update epoch.

The procedure continues to step 235 and the ASD module 114 utilizes the computed ratio value as a scale factor for the spectral density. In an embodiment, the computed ratio value may be used to adjust or maintain the spectral density for an error model. Specifically, and as explained above, Pₖ⁻=Φ_{k-1,k}P⁻Φ_{k-1,k}^{T}+Qₖ of the update procedure implemented by the INS filter 113 may be the error model. Additionally, Qₖ may correspond to the spectral density. Therefore, the ASD module 114 may multiply Qₖ by Ratioₖ, which serves as a scale factor, to adjust the spectral density. For example, and when the ratio value is large value, the spectral density is increased to account for the disturbed environmental operating conditions. When the ratio value is 1 or close to 1, the spectral density remains at a steady state value for the steady state environment.

Therefore, and in embodiment, the error model may be generated or modified for varying environmental operation conditions at different points in time (e.g., start-up, after start-up, etc.) by adjusting the spectral density using Ratioₖ that is computed according to the one or more embodiments as described herein.

The procedure optionally continues to step 240, and the filter (e.g., INS filter 113) uses the model (e.g., error model) with a spectral density that is scaled using the ratio value. For example, an INS filter 113 may use an error model to account for the IMU errors and compute a solution (e.g., navigation solution). As a result, the INS filter 113 can efficiently and accurately implement the update procedure to compute a solution (e.g., navigation solution) in the varying environmental operating conditions at different points in time (e.g., start-up, after start-up, etc.) based on the adaptable spectral noise density according to the one or more embodiments as described herein. As such, the one or more embodiments as described herein provide an improvement over conventional systems that use static models that cannot be efficiently utilized in varying environmental conditions.

Specifically, such conventional systems may use a steady state static model that will mischaracterize the increased IMU errors in disturbed environments since the process noise is set for operating in a steady state environment. Further, other conventional systems may use a static model with increased noise. However, such static models introduce increased noise that negatively impacts the INS filter 113 during steady state.

In contrast, the one or more embodiments as described herein can adapt/adjust the spectral noise density such that different models (e.g., error models) can be used for varying environmental operating conditions. Advantageously, the INS filter 113 can efficiently and accurately compute a solution (e.g., navigation solution) in the varying environmental operating conditions, at different points in time during operation, based on the adaptable spectral noise density.

The use of the adjusted spectral density (e.g., adjusted based on internal data as described in relation to FIG. 2) in varying environmental operating conditions to compute a solution is a practical application and solution provided by the one or more embodiments as described herein. Specifically, the spectral density that is adjusted based on internal data as described herein is a practical/technical solution that allows a filter (e.g., INS filter 113) to seamlessly, on-the-fly, and in near-real time compute a solution (e.g., navigation solution) efficiently while operating in an environment with changing/varying conditions. This is an improvement when compared to the discussed conventional systems and techniques that can either use a static steady-state model or a model with increased spectral density to compute a solution, both of which are nonoptimal in environments with changing/varying operating conditions. Therefore, the one or more embodiments as described herein provide an improvement in the existing technological fields of solution filtering, navigation solution filtering, Kalman filtering, signal tracking filtering, to name a few.

The procedure continues to step 245 and the ASD module 114 continues to a next epoch. In this example, the next update epoch is update epoch 6. As such, the procedure continues to step 210 for a next iteration of procedure 200 where update epoch 6 is the current update epoch. Thus, the procedure 200 is performed again and iteratively for a current update epoch, e.g., update epoch 6. For example, an error correction value is obtained for update epoch 6, a rolling history (History epoch 2) is created, a value (e.g., RMS) is computed for the rolling history, long-term and short-term averages are computed, a ratio value is computed for update epoch 6, and the ratio value is used as a scale factor for the spectral density.

In addition to using internal data, the one or more embodiments as described herein can adjust the spectral density for varying environmental operating conditions based on data from one or more sensors (e.g., from the one or more environmental sensors 117 and/or one or more sensors of IMU 112 such as an IMU temperature sensor). As used herein, data from the one or more sensors may be referred to as “external data” since the data is not obtained from, i.e., not internal to, the filtering process implemented by INS filter 113 (e.g., Kalman Filter).

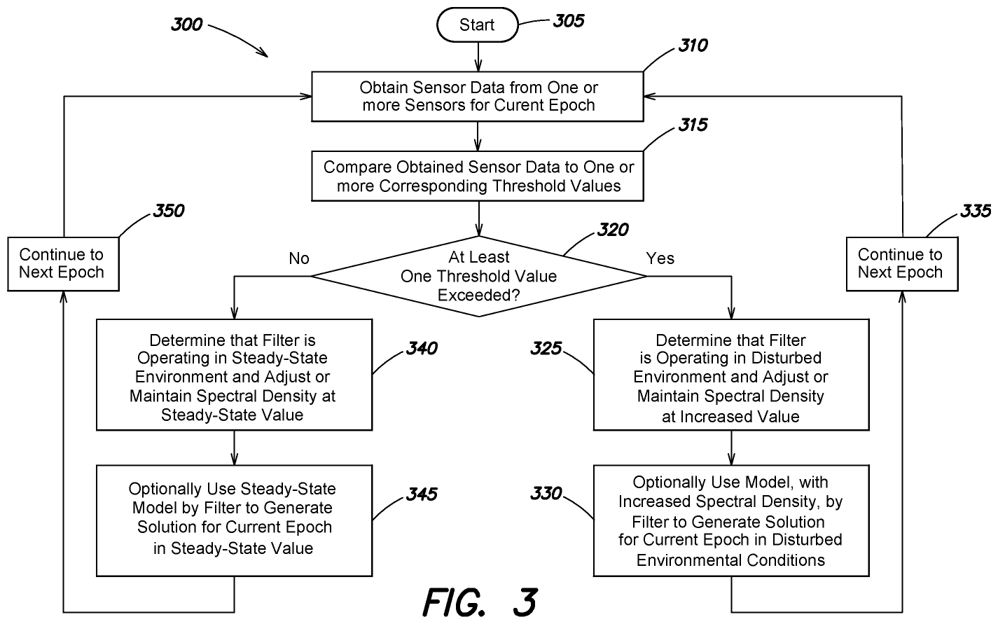

FIG. 3 is a flow diagram of a sequence of steps for using external data to adapt a spectral density based on varying environmental operating conditions according to the one or more embodiments as described herein.

The procedure 300 starts at step 305 and continues to step 310 where the ASD module 114 obtains sensor data for a current epoch. In an embodiment, the sensor data may be obtained from one or more different sensors. For example, the sensors may include, but are not limited to, IMU sensors, optional environmental sensors 117 that are coupled to body of interest 102, etc.

As an illustrative example, let it be assumed that the ASD module 114 obtains temperature data (i.e., external data) from a temperature sensor and vibration sensor data from a vibration sensor, both of which are optional environmental sensors 117. Although the illustrative example used herein describes data being obtained from optional environmental sensors 117, it is expressly contemplated that the one or more embodiments as described herein are applicable to data from IMU sensors, a combination of optional environmental sensors 117 and IMU sensors, or any other sensors that are, for example, external to the operation of a filtering process.

The procedure continues to step 315 and the ASD module 114 compares each of the obtained sensor data with one or more corresponding threshold value. As an illustrative example, let it be assumed that there is a single temperature threshold value t. Further, let it be assumed there are two vibration threshold values (e.g., a lower vibration threshold value and a higher vibration threshold value).

Although the example as described herein uses threshold, it is expressly contemplated that the ASD module 114 may utilize different sensor patterns, profiles created for sensors, a combination of sensor patterns and profiles, etc. to determine when certain conditions, indicative of a disturbed environment, are met to adjust the spectral density.

For this example, the temperature threshold value may be used to define an operating environment disturbed by temperature. Specifically, if the temperature sensor data is less than or equal to the temperature threshold value, the ASD module 114 may determine that the INS filter 113 is not operating in an environment that is disturbed by temperature (e.g., the INS filter is operating in a steady state environment) for the current epoch. However, if the temperature sensor data is greater than the temperature threshold value, the ASD module 114 may determine that the INS filter 113 is operating in an environment that is disturbed by temperature for the current epoch.

The vibration threshold values may be used to define an operating environment disturbed by vibrations. Specifically, if the vibration sensor data is less than or equal to the lower vibration threshold value, the ASD module 114 may determine that the INS filter 113 is not operating in an environment that is disturbed by vibrations (e.g., the INS filter is operating in a steady state environment) for the current epoch. If the vibration sensor data is greater than the lower vibration threshold value but less than or equal to the higher vibration threshold value, the ASD module 114 may determine that the INS filter 113 is operating in an environment that is mildly disturbed by vibrations for the current epoch. If the vibration sensor data is greater than the higher vibration threshold value, the ASD module 114 may determine that the INS filter 113 is operating in an environment that is greatly disturbed by vibrations for the current epoch.

The procedure continues to step 320 and the ASD module 114 determines if at least one threshold value is exceeded. For example, the ASD module 114 may determine if the temperature sensor data exceeds the temperature threshold value to determine if the environmental operating conditions are disturbed by temperatures. Additionally, the ASD module 114 may determine if the vibration sensor data exceeds either of the two vibration threshold values to determine if the environmental operation conditions are mildly or greatly disturbed by vibrations.

If at least one threshold value is exceeded, the procedure continues from step 320 to step 325. At step 325, the ASD module 114 determines that the filter (e.g., INS filter 113) is operating in a disturbed environment. As such, the ASD module 114 adjusts the spectral density to an increased value or maintains the spectral density at an existing increased value. The determination of whether the ASD module 114 adjusts the spectral density to an increased value or maintains it at an existing increased value may be based on the value of the spectral density for the previous epoch. For example, if the spectral density value for the previous epoch is at a steady state value, the ASD module 114 adjusts the spectral density value to an increased value to account for the disturbed environmental operating conditions. However, if the spectral density value for the previous epoch is at the increased value because of the disturbed environment operating conditions during the previous epoch, the ASD module 114 maintains the spectral density value at the increased value. Because the increased spectral density value is input to a model (e.g., error model), the IMU corrections are more heavily weighted such that the IMU corrections have a larger influence/impact when used by the error model to compute the solution (e.g., navigation solution) in the disturbed environmental operating conditions.

For example, and as previously explained, Pₖ⁻=Φ_{k-1,k}P⁻Φ_{k-1,k}^{T}+Qₖ of the update procedure implemented by the INS filter 113 may be the error model. Additionally, Qₖ may correspond to the spectral density. Therefore, the ASD module 114 may multiply Qₖ by an increased scale factor to increase the spectral density. As such, the error model may be generated or modified by increasing the spectral density to account for the disturbed environmental operating conditions.

The procedure continues from step 325 to step 330. At optional step 330, the filter (e.g., INS filter 113) uses the model (e.g., error model), which includes an increase to the allowable system noise based on the increased spectral density, to efficiently and accurately compute a solution in the disturbed environmental operating conditions. The procedure continues to step 335, and the ASD module continues to a next epoch. The procedure then repeats to determine if the spectral density should be at an increased value or a steady state value for the next epoch.

If at least one threshold value is not exceeded at step 320, the procedure continues from step 320 to step 340. At step 340, the ASD module 114 determines that the filter (e.g., INS filter 113), is not operating in disturbed environment. As such, the ASD module 114 adjusts the spectral density to a steady state value or maintains the spectral density at an existing steady state value. For example, if the spectral density value for the previous epoch is at a steady state value, the ASD module 114 maintains the spectral density value at the steady state value to account for the steady state environment. However, if the spectral density value for the previous epoch is at the increased value because of the disturbed environment operating conditions during the previous epoch, the ASD module 114 may adjust the spectral density value to the steady state value.

As previously explained, Pₖ⁻=Φ_{k-1,k}P⁻Φ_{k-1,k}^{T}+Qₖ of the update procedure implemented by the INS filter 113 may be the error model. Additionally, Qₖ may correspond to the spectral density. Therefore, the ASD module 114 may multiply Qₖ by a steady state scale factor. As such, the error model may be generated or modified by adjusting the spectral density to account for the steady state environment.

The procedure continues from step 340 to step 345. At optional step 345, the filter (e.g., INS filter 113) uses the steady state model (e.g., steady state error model) to efficiently and accurately compute a solution (e.g., navigation solution) in the steady state environment. The procedure continues to step 350 and the ASD module continues to a next epoch. The procedure then repeats to determine if the spectral density should be at an increased value or a steady state value for the next epoch.

Accordingly, the environmental conditions in which the filter (e.g., INS filter) 113 is operating may be evaluated to adapt the spectral noise density at different points in time (e.g., at start-up, after start-up). This in turn updates/modifies the error model to account for varying environmental conditions at the different points in time. Advantageously, the (e.g., INS filter 113) can efficiently and accurately determine a solution (e.g., navigation solution) in varying environmental operating conditions at the different points in time. As such, the one or more embodiments as described herein provide an improvement in the existing technological field of solution filtering (e.g., navigation solution filtering, Kalman filtering, signal tracking filtering, etc.) when compared to conventional systems that may use static error models.

The use of the adjusted spectral density (e.g., adjusted based on external data as described in relation to FIG. 3) in varying environmental operating conditions is a practical application and solution provided by the one or more embodiments as described herein. Specifically, the spectral density that is adjusted based on external data (e.g., sensor data) as described herein is a practical/technical solution that allows a filter (e.g., INS filter 113) to seamlessly, on-the-fly, and in near-real time compute a solution (e.g., navigation solution) efficiently while operating in an environment with changing/varying conditions. This is an improvement when compared to the discussed conventional systems and techniques that can either use a static steady-state model or a model with increased spectral density to compute a solution, both of which are nonoptimal in environments with changing/varying operating conditions.

Although not explicitly included in FIG. 3, it is expressly contemplated that a rolling history may be created for the obtained sensor data and sensor data from one or more previous epochs as described above in relation to FIG. 2. The creation of the rolling history may be performed between steps 310 and 315 of FIG. 3. One or more statistical analyses may be performed on the sensor data of the rolling history to obtain a statistical representation for the current epoch from the rolling history, as described above in relation to FIG. 2. The statistical analyses may be performed after creating the rolling history and before performing step 320 of FIG. 3. The statistical representation may be compared to the threshold value at step 320 and the procedure 300 may be performed as described above to determine if the filter is operating in a steady state or disturbed environment.

Instead of comparing the statistical representation to a threshold at step 320, it is expressly contemplated that a long-term average and short-term average, as described above, may be computed for the statistical representation from the sensors. The long-term and short-term averages may then be compared to adjust the spectral density, as described above in relation to FIG. 2.

In addition to utilizing internal data and/or external data to adjust the spectral density as described above in relation to FIGS. 2 and 3, the one or more embodiments as described herein may use misclosure values to switch between filters that use different error models. Specifically, and as will be described in further detail below, a primary filter may use a steady state error model and a secondary/backup filter may use an error model (i.e., disturbed error model) that utilizes more heavily weighted IMU corrections such that the IMU corrections have a larger impact/influence when the solution (e.g., navigation solution) is computed in disturbed environmental conditions. The misclosure values from the filters may be compared to determine which of the primary filter and secondary filter should be used.

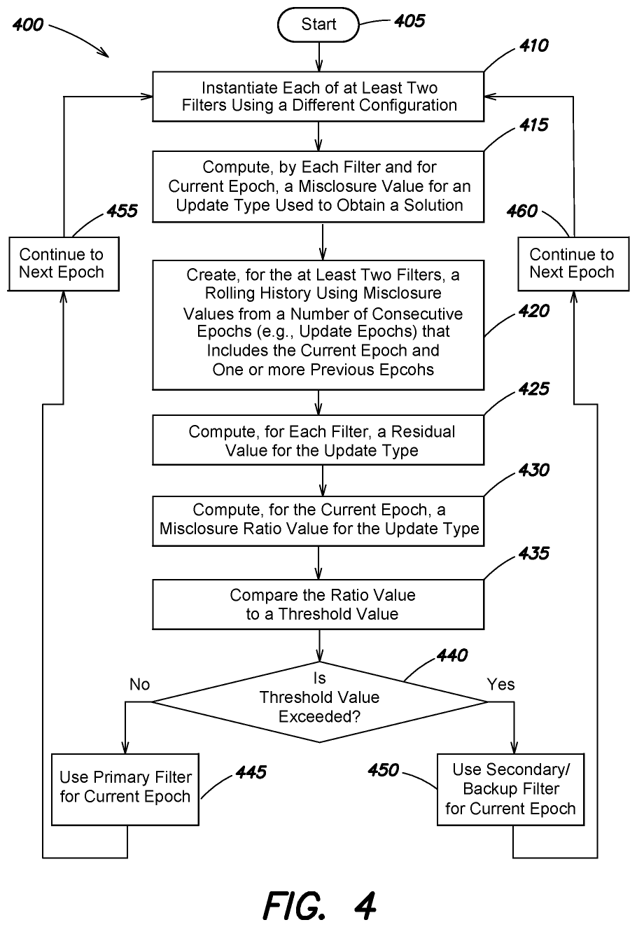

FIG. 4 is a flow diagram of a sequence of steps for using misclosure values to switch between filters that use different models according to the one or more embodiments as described herein. Although the examples as described in relation to FIG. 4 use two different filters (e.g., INS filters), it is expressly contemplated that any number of a plurality of filters (e.g., 2, 3, 4, 5, 6, etc.) may be used according to the one or more embodiments as described herein. As such, the discussion of two different filters in relation to FIG. 4 is for illustrative purposes only. In an embodiment, steps 415 through 450 of FIG. 4 may be performed in the solution domain. The solution domain may be a point in time during or after the INS 110 and/or receiver 104 compute a navigation solution and/or update a navigation solution. For example, the INS 104 computes the GNSS/INS solution in the solution domain. In an embodiment, the INS 110 and/or receiver 104 operate in an observation domain at a point in time prior to the INS 110 and/or receiver 104 computing a navigation solution and/or updating a navigation solution. For example, the IMU measurements, the GNSS raw measurements, and the GNSS observables may be obtained in the observation domain.

The procedure 400 starts at step 405 and continues to step 410 where the processor instantiates each of at least two filters (e.g., INS filters) using a different configuration. As an illustrative example, let it be assumed that at least two INS filters include a first INS filter, e.g., filter 1, and a second INS filter, e.g., filter 2. Filter 1 and filter 2 may compute, in parallel, their respective GNSS/INS solutions.

In this example, let it be assumed that filter 1 is the primary INS filter and filter 2 is the secondary/backup filter. As such, filter 1 with a steady state error model may be used to compute a GNSS/INS solution until it is determined that the environmental operating conditions have changed due to a disturbance, (e.g., detecting a temperature, detecting fluctuations (i.e., changes) in the temperature, detecting a rate of change in the temperature, detecting vibrations, detecting fluctuations in the vibrations, detecting a rate of change in the vibrations, detecting a magnetic field, detecting fluctuations in the magnetic field, detecting a rate of change in the magnetic field, or any other type of potential disturbance in the environmental operating conditions that may be detected by a source of information, etc.). When a disturbance is detected, the INS filter 2 with a disturbed error model may be used to compute a GNSS/INS solution in the disturbed environment. When it is determined that the environment has returned to steady state, i.e., without a disturbance, filter 1 may be used again to compute a GNSS/INS solution.

According to the one or more embodiments as described herein, filter 1 and filter 2 are configured differently by using different error models. Specifically, filter 1 may utilize an error model that is based on a spectral density value that corresponds to a steady state environment. For example, the spectral density value may be based on the steady state statistics provided by a manufacturer of the INS filter. Filter 2 may utilize an error model that is based on an increased spectral density value for disturbed environmental operating conditions.

Because filters 1 and 2 are configured differently, filters 1 and 2 operate differently to compute misclosure values and/or output solutions (e.g., GNSS/INS solution) using the same data (e.g., IMU data). As will be described in further detail below, values computed from the misclosure values of filters 1 and 2 can be analyzed in the solution domain to determine if an environmental disturbance has occurred such that, for example, one or more actions (e.g., switchover from filter 1 to filter 2) can be taken.

The procedure 400 continues to step 415 and each of the at least two filters, for a current epoch, computes a misclosure value for each update type that is used to obtain a solution (e.g., GNSS/INS solution). For this example, let it be assumed that there is a single update type and that the update type is a position update. Based on the different configurations (e.g., use of different error models), filters 1 and 2 can each use a received position update to compute a position misclosure value. Accordingly, and for this example, each of filters 1 and 2 computes a position misclosure value.

In an embodiment, a misclosure value may represent or indicate a difference (i.e., divergence) between two solutions that are utilized to determine a combined solution at a filter for an update type. For example, a misclosure value may represent or indicate a difference between a GNSS solution and an INS solution for an update type at filter 1. An increasing misclosure value may be indicative of the INS solution and GNSS solution becoming more different. Conversely, a decreasing misclosure value or a misclosure value nearing zero may be indicative of the INS solution and the GNSS solution becoming more equal/consistent. As an example, let it be assumed that the current update epoch is update epoch 5 and that filter 1 and filter 2, using two different error models, compute the following misclosure values for position:

| Update | INS Filter 1 | INS Filter 2 |
|---|---|---|
| Epoch | Position Misclosure (m) | Position Misclosure (m) |
| 5 | 10.665 | 0.913 |

In the table above, m may be a unit and represent meters. Further, the table above indicates that the INS solution and GNSS solution are more different at filter 1 than they are at filter 2.

Procedure 400 continues to step 420 and the ASD module 114 creates, for the at least two filters, a rolling history using misclosure values from a number of consecutive epochs (e.g., update epochs) that includes the current epoch and one or more previous epochs. In an embodiment, the number, e.g., window size, of consecutive update epochs is 5 and the ASD module 114 creates a rolling history using the misclosure values from the 5 consecutive update epochs.

A window size of 5 is for illustrative purposes only, and it is expressly contemplated that the window size may be of any value. In an embodiment, the window size may be any value that is equal to or greater than 2. For this example, let it be assumed that the window size is 5. As such, the ASD module 114 may create a rolling history (History Epoch 1) that includes 4 previous update epochs, e.g., update epochs 1 through 4, and the current update epoch, e.g., update epoch 5. Therefore, History Epoch 1 includes the misclosure values from update epochs 1 through 5. For example, the ASD module 114 may create History Epoch 1 as follows:

History Epoch 1

| Update | Filter 1 | Filter 2 |
|---|---|---|
| Epoch | Position Misclosure (m) | Position Misclosure (m) |
| 1 | 1.958 | 0.615 |
| 2 | 4.849 | 0.338 |
| 3 | 6.593 | 0.338 |
| 4 | 8.891 | 0.695 |
| 5 | 10.665 | 0.913 |

After the completion of procedure 400 where the current epoch is epoch 5, the next epoch will be the current epoch. For this example, let it be assumed that the next epoch is epoch 6. When epoch 6 is the current update epoch, the procedure 400 repeats for a next iteration, and the ASD module 114 may create a next rolling history (History Epoch 2) at step 420 for the next iteration. History Epoch 2 may be created by removing the oldest epoch (e.g., update epoch 1) from History Epoch 1 and adding the error correction value for update epoch 6 to History Epoch 1. Therefore, History Epoch 2 includes epochs 2, 3, 4, 5, and 6 and their respective misclosure values.

The procedure continues to step 425 and the ASD module 114 computes, for each filter, a residual value for the update type. In an embodiment, the ASD module 114 computes a residual value for the update type utilizing the misclosure values from the rolling history. The ASD module 114 may use an RMS to compute the position residual value in a similar manner as described above with relation to step 220 of FIG. 2. As such, the ASD module 114 uses the RMS to compute the position residual value for filter 1 as 7.261. The ASD module 114 uses the RMS to compute the position residual value for filter 2 as 0.620.

An RMS value is a measure of the magnitude of a set of numbers. Since a misclosure value represents the difference between the GNSS solution and the INS solution, an increasing RMS value indicates an increasing magnitude of difference between the GNSS solution and the INS solution over the rolling history. As such, a residual value may represent a magnitude of the difference between the GNSS solution and the INS solution at a filter for an update type over the rolling history.

Procedure 400 continues to step 430 and the ASD module 114 computes, for the current epoch, a misclosure ratio value for the update type. For example, the position residual values for filters 1 and 2 that correspond to update epoch 5 are 7.261 and 0.620, respectively. As such, the ASD module 114 may compute the position misclosure ratio (PMR) value at update epoch 5 as follows:

$$PMR = \frac{7.261}{0.620} = 11.711$$

In this example, filter 1 corresponds to the numerator and filter 2 corresponds to the denominator. According to the one or more embodiments as described herein, a ratio value increasing from 1 may indicate that the difference between the GNSS solution and INS solution at filter 1 is becoming larger than the difference between the GNSS solution and INS solution at filter 2. The difference becoming larger at filter 1 versus filter 2 may be the result of filter 1 using the steady state error model. For example, if filter 1 is operating in a disturbed environment during the current epoch, the steady state error model will not accurately characterize the IMU errors caused by the disturbances. Accordingly, the INS solution and GNSS solution at filter 1 will diverge from each other when filter 1 operates in a disturbed environment.

A ratio value decreasing from 1 may indicate that the difference between the GNSS solution and the INS solution at filter 2 is becoming larger than the difference between the GNSS solution and the INS solution at filter 1. The difference becoming larger at filter 2 versus filter 1 may be the result of filter 2 using an error model with an increased spectral density. For example, if filter 2 is operating in a steady state environment during the current epoch, the error model with the increased spectral density will introduce noise that will negatively affect filter 2 in computing the solution in the steady state environment. Accordingly, the INS solution and GNSS solution at filter 2 will diverge from each other when filter 2 operates in a steady state environment.

The procedure continues to step 435 and the ASD module 114 compares the ratio value to a threshold value. For this example, let it be assumed that the threshold value is 5. In an embodiment, the threshold value may be preconfigured or user defined.

The procedure continues to step 440 and the ASD module 114 determines if the threshold value is exceeded. If it is determined that the threshold value is not exceeded at step 440, the procedure continues to step 445. At step 445, the primary filter is used for the current epoch. Specifically, the threshold value may represent a level at which the INS solution and GNSS solution are sufficiently similar at the primary filter, thus indicating that the INS filter 113 is operating in a steady state environment such that the steady state error model should be used. Therefore, the ASD module 114 may determine that if the ratio value does not exceed the threshold value, the operating environment does not include a disturbance that would require the use of an error model with an increased spectral density. As such, the primary filter is used for the current epoch.

If the primary filter was used for the previous epoch, the primary filter is continued to be used for the current epoch at step 445. If the secondary/backup filter was used for the previous epoch, the ASD module 114 performs a switchover such that the primary filter is used for the current epoch at step 445.

If it is determined that the threshold value is exceeded at step 440, the procedure continues to step 450. At step 450, the secondary/backup filter is to be used for the current epoch. Again, the threshold value represents a level at which the INS solution and GNSS solution are sufficiently similar at the primary filter such that the steady state error model should be used. Therefore, the ASD module 114 may determine that if the ratio value exceeds the threshold value, the operating environment includes a disturbance that requires the use of an error model with an increased spectral density. As such, the secondary/backup filter is used for the current epoch.

If the primary filter was used for the previous epoch, the ASD module 114 performs a switchover such that the secondary/backup filter is used for the current epoch at step 450. If the secondary/backup filter was used for the previous epoch, the secondary/backup filter is continued to be used for the current epoch at step 450.

The procedure continues from steps 445 and 450 to steps 455 and 460, respectively. At steps 455 and 460 the ASD module 114 continues to the next epoch. In this example, the next update epoch is update epoch 6. As such, the procedure continues to step 410 for a next iteration of procedure 400 where update epoch 6 is the current update epoch. Thus, the procedure 400 is performed again and iteratively for a current update epoch to determine whether to use a primary filter using a steady state error model or a secondary/backup filter using an error-model with an increased spectral density.

Advantageously, a solution can be determined in real-time, i.e., near-real time, for varying environmental operating conditions using the primary or secondary/backup filter at different points in time (e.g., at start-up, after start-up) based on determining if the environment is steady state or includes a disturbance. As such, the one or more embodiments as described herein provide an improvement in the existing technological field of solution filtering (e.g., navigation solution filtering, Kalman filtering, signal tracking filtering, etc.) over conventional systems that use a single static error model that cannot be used to accurately and efficiently determine a navigation solution in varying environmental conditions.

The use of the primary filter and the secondary filter based on varying environmental operating conditions as described in relation to FIG. 4 is a practical application and solution provided by the one or more embodiments as described herein. Specifically, a filter, e.g., INS filter 113, can switch between using a steady-state error model of a primary filter or a disturbed error-model of a secondary filter in real-time and seamlessly while in an environment with changing/varying operating conditions based on an analysis of the misclosure values associated with the two filters. This is an improvement when compared to the discussed conventional systems and techniques that can either use a static steady-state model or a model with increased spectral density, both of which are nonoptimal in environments with changing/varying operating conditions.

It should be understood that a wide variety of adaptations and modifications may be made to the techniques. For example, the steps of the flow diagrams as described herein may be performed sequentially, in parallel, or in one or more varied orders. Additionally, any of the flow diagrams may be performed in any combination. For example, the external data and the internal data may be used together, as described in relation to FIG. 2 and FIG. 3, to adjust or maintain the spectral density such that the INS filter 113 can operate in varying environmental conditions. Further, although the examples as described herein may refer to INS filters, it is expressly contemplated that the one or more embodiments as described herein are applicable to any of a variety of different types of filters. For example, the one or more embodiments as described herein may be applicable to signal tracking filters, Kalman filters, or any type of filters used to determine a solution (e.g., navigation solution). When the one or more embodiments as described herein are used with Kalman filters, such Kalman filters may be GNSS Kalman filters. Such GNSS Kalman filters may include, but are not limited to, GNSS Kalman filters used in Precise Point Positioning (PPP), Real-Time Kinematic Positioning (RTK), delta-phase positioning components, etc. Further, although the examples as described herein are rounded to a particular number of decimal digits, it is expressly contemplated that the one or more embodiments as described herein may be implemented using values that are rounded to any number of decimal digits in order to, for example, obtain different precision. As such, it should be understood that the examples as utilized herein are for illustrative purposes only.

In general, functionality may be implemented in software, hardware, or various combinations thereof. Software implementations may include electronic device-executable instructions (e.g., computer-executable instructions) stored in a non-transitory electronic device-readable medium (e.g., a non-transitory computer-readable medium), such as a volatile memory, a persistent storage device, or other tangible medium. Hardware implementations may include logic circuits, application specific integrated circuits, and/or other types of hardware components. Further, combined software/hardware implementations may include both electronic device-executable instructions stored in a non-transitory electronic device-readable medium, as well as one or more hardware components. Above all, it should be understood that the above description is meant to be taken only by way of example.

1. A method for adjusting a spectral density used to compute a filtering solution, the method comprising:
obtaining, by a processor, current error correction data for a current epoch, wherein the error correction data is used to correct errors introduced into the filtering solution;
creating a rolling history that includes the current error correction data for the current epoch and previous error correction data for one or more previous epochs;
computing, for the rolling history, a statistical value from the current error correction data and the previous error correction data;
utilizing the statistical value with a baseline indicator to detect if a condition has occurred; and
in response to determining that the condition has occurred, adjusting the spectral density used to compute the filtering solution for the current epoch.

2. The method of claim 1, further comprising:
utilizing the statistical value to compute a short-term average;
utilizing the statistical value to compute a long-term average that represents the baseline indicator;
computing a ratio value using the short-term average and the long-term average;
determining that the condition occurred when the ratio value exceeds a threshold;
using the adjusted spectral density as input to a model when the ratio value exceeds the threshold; and
computing, by a filter influenced by one or more environmental operating conditions, the filtering solution using the model.

3. The method of claim 2, wherein the filter is an inertial navigation system (INS) filter.

4. The method of claim 1, wherein current error correction data is generated during an update procedure implemented by a Kalman filter.

5. The method of claim 1, wherein the one or more environmental conditions include one or more of a (1) temperature, (2) vibrations, (3) magnetic field, or (4) an inclusion or exclusion of a potential disturbance.

6. The method of claim 5, wherein
the baseline value is a steady state value based on a steady state environmental conditions, and
the updated value is an increased value, when compared to the steady state value, based on (1) a detection of a temperature, a detection of a change in the temperature, a detection of a rate of change in the temperature, detection of vibrations, a detection of change in the vibrations, a detection of a rate of change in the vibrations, a detection of a magnetic field, a detection of a change in the magnetic field, or a detection of a rate of change in the magnetic field or (2) a source of information providing an indication of the potential disturbance in the environmental operating conditions, and
the increased value causes an increase weight to be applied to error correction values that are included in the model.

7. The method of claim 1, wherein the statistical analysis is performed using a root mean square (RMS), an absolute accumulation, a standard deviation, or a slope.

8. The method of claim 1, wherein the current error correction data is inertial measurement unit (IMU) error correction data.

9. A method for adjusting a spectral density used for a filtering solution, the method comprising:
obtaining, by a processor, sensor data for a current epoch, wherein sensor data measures or detects one or more different environmental operating conditions in which a filter operates;
comparing a sensor data value of the sensor data to at least one threshold value;
in response to determining that the sensor data value exceeds the at least one threshold value, adjusting or maintaining the spectral density to an increased value;
in response to determining that the sensor data does not exceed the at least one threshold value, adjusting or maintaining the spectral density to a steady state value; and
computing the filtering solution for the current epoch based on the filter using the increased value for the spectral density or the steady state value for the spectral density.

10. The method of claim 9, wherein the sensor data includes one or more of temperature data, vibration data, and magnetic field data.

11. The method of claim 9, further comprising:
using, by the filter operating in a disturbed environment, a model that uses the increased value for the spectral density as input; and
computing, by the filter, the filtering solution using the model.

12. The method of claim 11, wherein the filter is an inertial navigation system (INS) filter.

13. The method of claim 9, further comprising:
using, by the filter operating in a steady state environment, a model that uses the steady state value for the spectral density as input; and
computing, by the filter, the filtering solution.

14. The method of claim 13, wherein the filter is an inertial navigation system (INS) filter.

15. The method of claim 9, further comprising:
obtaining, by the processor, other sensor data for one or more previous update epochs;
creating a rolling history using the sensor data and the other sensor data;
performing a statistical analysis using the sensor data and the other sensor data to generate a statistical analysis value;
comparing the statistical analysis value to the at least one threshold value;
in response to determining that the statistical analysis value exceeds the at least one threshold value, adjusting or maintaining the spectral density to the increased value; and
in response to determining that the statistical analysis value does not exceed the at least one threshold value, adjusting or maintaining the spectral density to the steady state value.

16. The method of claim 15, wherein the statistical analysis is performed using a root mean square (RMS), an absolute accumulation, a standard deviation, or a slope.

17. A system for adjusting a spectral density used to compute a solution, the method comprising:
a memory;
a processor coupled to the memory, the processor executing a module that is configured to:
obtain current error correction data for a current epoch, wherein the error correction data is used to correct errors introduced into the solution;
create a rolling history that includes the current error correction data for the current epoch and previous error correction data for one or more previous epochs;
compute, for the rolling history, a statistical value from the current error correction data and the previous error correction data;
utilize the statistical value with a baseline indicator to detect if a condition has occurred; and
adjust, in response to determining that the condition has occurred, the spectral density used to compute the solution for the current epoch.

18. The system of claim 17, wherein the module is further configured to:
utilize the statistical value to compute a short-term average;
utilize the statistical value to compute a long-term average that represents the baseline indicator;
compute a ratio value using the short-term average and the long-term average;
determine that the condition occurred when the ratio value exceeds a threshold;
use the adjusted spectral density as input to a model when the ratio value exceeds the threshold; and
compute, by a filter influenced by one or more environmental operating conditions, the filtering solution using the model.

19. The system of claim 18, wherein the filter is an inertial navigation system (INS) filter.

20. The method of claim 17, wherein the one or more environmental conditions include one or more of a (1) temperature, (2) vibrations, (3) magnetic field, or (4) an inclusion or exclusion of a potential disturbance.
